(19) United States
(12) Patent Application Publication
(10) Pub. No.: US 2009/0070074 A1
(43) Pub. Date: Mar. 12, 2009

(54) Method and system for structural development and optimization

(76) Inventor: Anilkumar Chigullapalli, Pune (IN)

Correspondence Address: Pearl Cohen Zedek Latzer, LLP, 1500 Broadway, 12th Floor, New York, NY, 10036, US

(21) Appl. No.: 11/898,400

(22) Filed: Sep. 12, 2007

(51) Int. Cl. G06F 17/50

(52) U.S. Cl. 703/1

(57) ABSTRACT

The present invention relates to a method and system for structural development and optimization where a knowledge model relating to specially identified characteristics of the design is created and the variables of various phases are suitably transpired as inputs to the knowledge model. The method improves the quality of various phases as inputs to the knowledge model.

### BACKGROUND OF THE INVENTION

Structural development is usually carried out in a number of phases. The details of the design evolve over these phases. Typically it consists of four phases (1) Concept Evaluation (2) Concept Development (3) Detailed Design (4) Design Refinement based on physical validation.

For each of the above phases optimization is carried out. During each phase, performance evaluation usually involves computer based analyses (typically Finite Element simulations) which are very expensive. In order to reduce the total number of such analysis, approximation Models (also referred as Meta Models) are used to represent a relation between the Design Variables & the Performance Criteria.

The invention proposes to replace these Meta Models with one knowledge model that can be used in all the phases of structural development. The knowledge model will relate the specially identified characteristics of the design to the performance criteria. Since the design variables are different in each phase, suitable transformation will be used to calculate the special characteristics before giving them as inputs to the knowledge model.

### BRIEF DESCRIPTION OF THE DRAWINGS

FIG. 1: Optimization process using different Meta Models in each phase.

FIG. 2: Improved optimization process using knowledge model.

FIG. 3: Concept Evaluation Phase of the structural design

FIG. 4: Concept Development Phase of the structural design

### DETAILED DESCRIPTION OF THE DRAWINGS

The process of structural development consists of a number of phases and optimization is carried out in each of the phases leading up to optimized design. The invention is meant to improve this process by reducing the computational effort with the help of the design performance related knowledge, generated in all the phases.

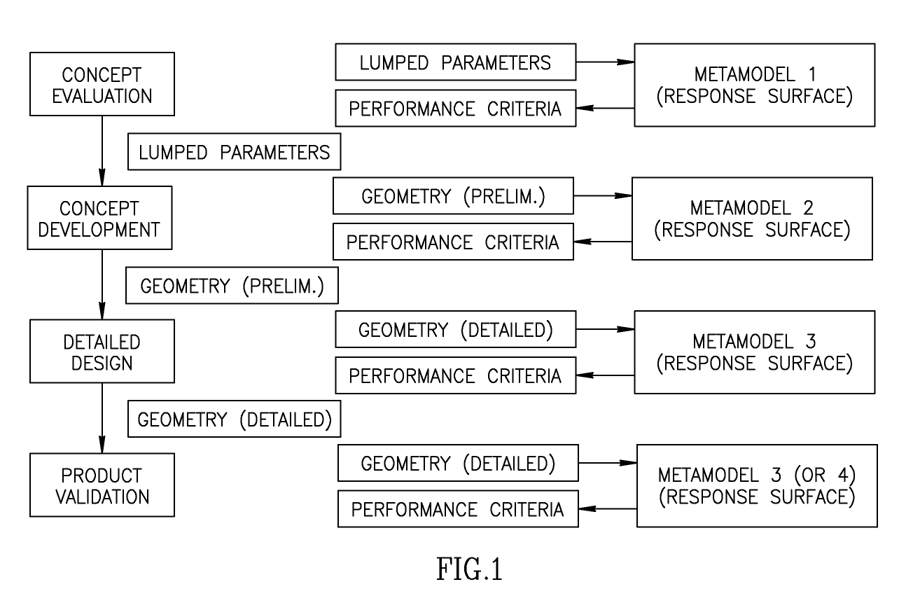

A typical structural development process consists of four phases (1) concept evaluation (2) concept development (3) detailed design (4) Design refinement based on physical validation. During each phase, performance evaluation usually involves computer based analysis (Finite Element simulations) which are very expensive. In order to reduce the total number of such analysis, approximation models or Meta Models are used to represent a relation between the design variables and the performance criteria. The various functions of Meta Models at each stage of optimization are (1) concept evaluation phase—Meta Model 1 relates the lumped parameter values to the performance criteria (2) concept development phase—Meta Model 2 relates the dimensions of simplified geometry to the performance criteria (3) Detailed design phase and validation phase—Meta Model 3 relates the dimensions of detailed geometry of design to the performance criteria. These Meta Models are made accurate by repeatedly running a number of detailed analysis. (FIG. 1)

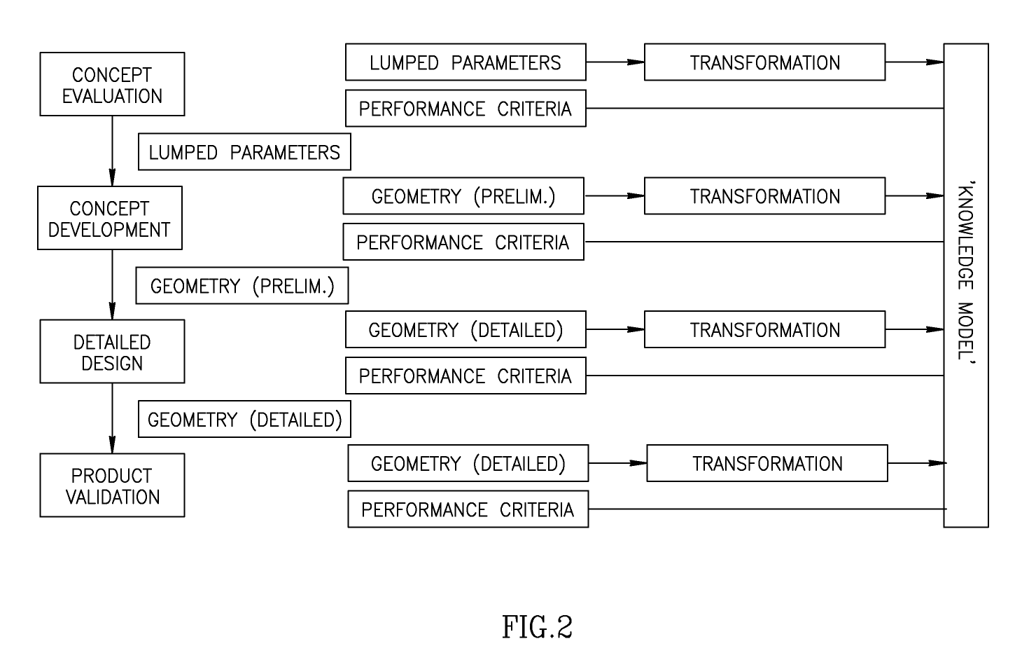

It is proposed to replace the number of Meta Models with one Knowledge Model that can be used in all the phases of structural development. The Knowledge model will relate the specially identified characteristics of design to the performance criteria. Since the design variables are different in each phase, suitable ‘transformation’ will be used to calculate the special characteristics before giving them as inputs to the Knowledge Model. This method will lead to the improvement in optimization as all the design knowledge generated in any phase is used in the next phase of the optimization. This will lead to reduced number of iterations in the later phases of the development to find an optimum solution (FIG. 2)

The invention is explained better with the following example of developing a chassis frame design. The same concept can be employed for all optimizations where approximation models or Meta Models are used. The main reason for carrying out optimization of a Chassis Frame is to find a design that meets various functional requirements like Torsion Stiffness with minimum weight and meeting other constraints like packaging. Optimization is carried out to determine various design dimensions in order to meet the stiffness requirement with minimum weight. Chassis frame being a complex system requiring a large number of design dimensions—the optimization is carried out systematically in phases with level of design detail increasing in each phase.

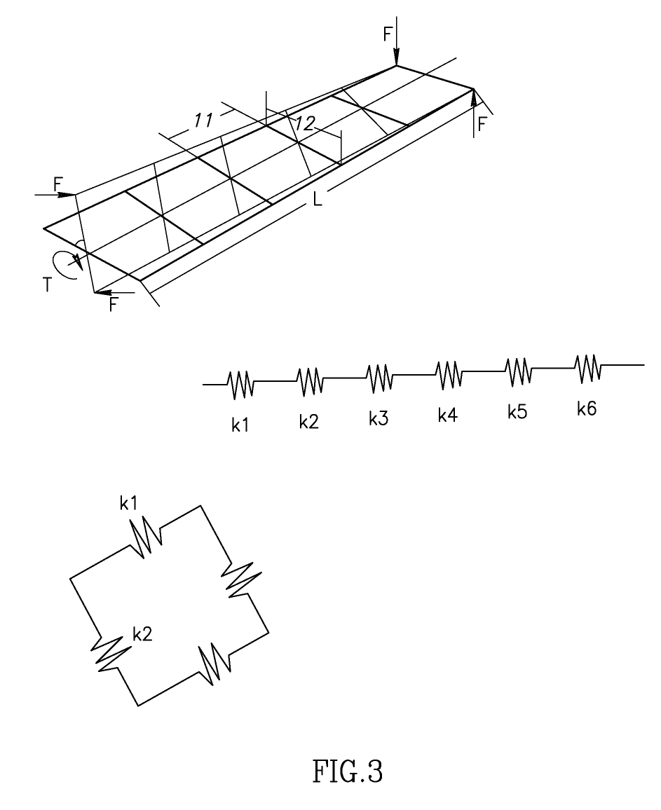

The chassis frame is modeled as a set of spring elements eg. Torsional stiffness. In case of the existing methods of design development the analysis is carried out by varying the stiffness element properties. A relation is determined between spring properties and stiffness properties and a Meta Model 1 is created. In the present invention at the concept evaluation phase, a unique set of properties are identified as Knowledge Model Inputs (KMIs). In our example of chassis frame, for torsional stiffness the important properties could be section modules, height of cross members and orientation of cross members (FIG. 3). The knowledge model is developed after a number of analysis are carried out by varying spring element properties. The knowledge model structure is formed as Torsional Stiffness=function (KMI) where the knowledge Model Inputs are calculated from the (spring element properties)

KMIs=Transform1 (spring element properties)

where the spring element properties are finalized based on optimization using the knowledge model and passed on to the next phase of structural development.

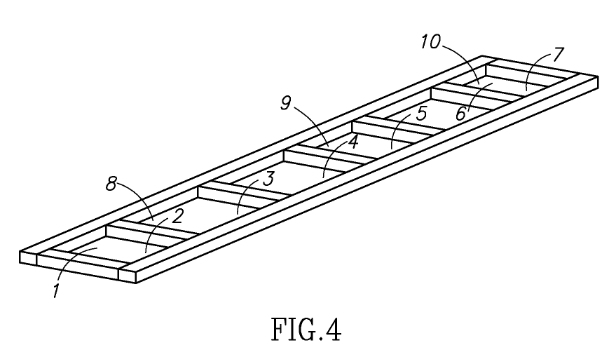

In the concept development phase the chassis is modeled as a single ladder frame with standard members. The sections of each member is estimated based on the values of K1, K2 etc determined in the earlier phase (FIG. 4). A new transformation is worked out for calculating the KMIs as KMIs=Transform 2 (section dimensions) as against the number of analysis runs carried out with different section dimensions. Section dimensions are then finalized through optimization using the knowledge model. The knowledge model can be passed on to the next phase of design work where as ‘Meta Model’ cannot be used in the next phase. Since the knowledge model is available form previous phase, a number of analysis runs, carried out to determine the ‘function 2’, are saved. This leads to reducing iterations. The solution is also better optimized as the Knowledge Model will be more accurate than Meta Model 2.

In the Detailed Design phase the chassis is modeled very accurately in terms of geometry. The knowledge Model will be more accurate than Meta Model 3 leading to reduced iterations and improved design. A unique knowledge model is created that is used across the phases. The knowledge model thus created undergoes improvement in each phase.

In the product validation phase the chassis is modeled very accurately in terms of geometry as in detailed design phase.

Meta Models are specific to a phase of design and undergo improvement only in a single phase. Since knowledge model is improved in each phase it is more accurate leading to better designs.

We claim:

1. A method of structural development and optimization process comprising the steps of identifying the special characteristic of the design; creating a knowledge model relating to the identified characteristics and improving the quality of the knowledge model by suitably transforming the variables of various phases as inputs to the knowledge model.

2. A method as claimed in claim 1 comprising the step of optimizing the knowledge model in each phase and providing it as input to the next consequent phase of the structural development process.

3. A system for the structural development and optimization process comprising
a means for creating a knowledge model relating to specially identified characterized of design;
a means for suitably transpiring the variables of various phases as inputs to the knowledge model

4. A system as claimed in claim 3 comprising a means for optimizing the knowledge model in each phase and providing it as input to then next phase of the structural development process.

5. A computer readable medium comprising instructions capable of performing the steps of identifying the special characteristics of the design; creating a knowledge model relating to the identified characteristics and improving the quality of the knowledge model by suitably transforming the variables of various phases as inputs to the knowledge model and optimizing the knowledge model in each phase of the structural development process.
